(19) United States
(12) Patent Application Publication
(10) Pub. No.: US 2008/0011802 A1
(43) Pub. Date: Jan. 17, 2008

(54) Cutting system for master liquid crystal panel having different alignment marks and method for cutting master liquid crystal panel

(75) Inventors: Ming-Fu Chen, Miao-Li (TW); Wen-Kai Chung, Miao-Li (TW); Cheng-Doul Chuang, Miao-Li (TW); Shih-Yao Lin, Miao-Li (TW); Hung-Wen Yang, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/879,240

(22) Filed: Jul. 16, 2007

(30) Foreign Application Priority Data
Jul. 14, 2006 (TW) 95125818

(51) Int. Cl. B26F 3/00

(52) U.S. Cl. 225/2; 225/96.5

(57) ABSTRACT

An exemplary cutting system (1) for a master liquid crystal panel includes a master liquid crystal panel (10) and two charge-coupled devices (12). The master liquid crystal panel includes four corners, and four alignment marks respectively provided at the corners. At least two of the alignment marks at two diagonal corners are different from each other, and the difference are selected from the group consisting of a difference in shape and a difference in distance from a center of the master liquid crystal panel. The charge-coupled devices are positioned adjacent to two adjacent corners of the mother liquid crystal panel at any one time, and are configured to detect and identify the alignment marks at such two adjacent corners. A related method for cutting the master liquid crystal panel is also provided.

### FIELD OF THE INVENTION

The present invention relates to a cutting system for a master liquid crystal panel. The cutting system is configured to ensure accurate cutting of the master liquid crystal panel into individual liquid crystal panels. The present invention also relates a method for cutting a master liquid crystal panel.

### GENERAL BACKGROUND

Liquid crystal displays are commonly used as display devices for compact electronic apparatuses, because they not only provide good quality images but are also very thin. A liquid crystal display generally includes a liquid crystal panel. In mass production of liquid crystal displays, a plurality of individual liquid crystal displays may be obtained by cutting a master liquid crystal panel into separate pieces.

Referring to FIG. 6, a typical cutting system 6 for a master liquid crystal panel includes a rectangular master liquid crystal panel 60 and a pair of charge-coupled devices (CCDs) 62. The master liquid crystal panel 60 has four corners (not labeled), and four alignment marks A6, B6, C6, D6 symmetrically located at the four corners. That is, each of the alignment marks A6, B6, C6, D6 is located at a respective one of the four corners. The alignment marks A6, B6, C6, D6 have a same shape, and maintain a same distance from a center (not labeled) of the master liquid crystal panel 60. The CCDs 62 can capture images of two adjacent of the alignment marks A6, B6, C6, D6 that are located nearest to the CCDs 62, in order to ensure the master liquid crystal panel 60 is correctly aligned in position.

In one example of a procedure of cutting the master liquid crystal panel 60, images of the alignment marks A6, B6 are captured by the CCDs 62. These images indicate that the master liquid crystal panel 60 is correctly aligned in position, and thus a cutting program is launched. According to the cutting program, the master liquid crystal panel 60 is cut into a plurality of individual liquid crystal panels (not shown).

However, the master liquid crystal panel 60 generally has a non-centrosymmetric structure. For example, peripheral parts of one of the liquid crystal panel portions of the master liquid crystal panel 60 may maintain different distances relative to a display part of the liquid crystal panel portion. This may also be the case for one or more of the other liquid crystal panel portions of the master liquid crystal panel 60. Therefore, in the above-described cutting procedure, the master liquid crystal panel 60 must be positioned as accurately as possible. On the other hand, because there is no difference between the alignment marks A6, B6, C6, D6, the cutting program is unable to identify with certainty whether the master liquid crystal panel 60 is inaccurately oriented or not. For example, short peripheral parts of the liquid crystal panel portions that should be located at a top position (as viewed in FIG. 6) may be wrongly located at a bottom position, yet images of the alignment marks C6, D6 captured by the CCDs 62 resemble the images of the alignment marks A6, B6. When this happens, the images of the alignment marks C6, D6 may be mistakenly interpreted as indicating that the master liquid crystal panel 60 is correctly aligned in position. The master liquid crystal panel 60 is then wrongly cut into individual liquid crystal panels, and one or more of such liquid crystal panels may be defective as a result. Each defective liquid crystal panel may have to be discarded. Thus, a reliability of the cutting system 6 may be seriously impaired, and a cost of manufacturing the liquid crystal panels can be unduly high.

What is needed, therefore, is a cutting system for a master liquid crystal panel that can overcome the above-described limitations and deficiencies. What is also needed is a cutting method using the cutting system.

### SUMMARY

In one preferred embodiment, a cutting system for a master liquid crystal panel includes a master liquid crystal panel, and at least one identification apparatus. The master liquid crystal panel includes a plurality of corners, and a plurality of alignment marks respectively provided at the corners. At least two of the alignment marks at two diagonal corners are different from each other, and the difference is selected from the group consisting of a difference in shape and a difference in distance from a center of the master liquid crystal panel. The at least one identification apparatus is positioned adjacent to two adjacent corners of the mother liquid crystal panel at any one time, and is configured (i.e., structured and arranged) to detect and identify the alignment marks at such two adjacent corners.

Other novel features, advantages and aspects will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of at least one embodiment of the present invention. In the drawings, like reference numerals designate corresponding parts throughout various views, and all the views are schematic.

FIG. 1 is a top plan view of a cutting system for a master liquid crystal panel according to a first embodiment of the present invention.

FIG. 2 is a flow chart summarizing an exemplary method for cutting the master liquid crystal panel of FIG. 1.

FIG. 3 is a top plan view of a cutting system for a master liquid crystal panel according to a second embodiment of the present invention.

FIG. 4 is a top plan view of a cutting system for a master liquid crystal panel according to a third embodiment of the present invention.

FIG. 5 is a top plan view of a cutting system for a master liquid crystal panel according to a fourth embodiment of the present invention.

FIG. 6 is a top plan view of a conventional cutting system for a master liquid crystal panel.

### DETAILED DESCRIPTION OF PREFERRED EMBODIMENTS

Reference will now be made to the drawings to describe preferred embodiments of the present invention in detail.

Referring to FIG. 1, a cutting system 1 for a master liquid crystal panel according to a first embodiment of the present invention is shown. The cutting system 1 includes a master liquid crystal panel 10 and a pair of CCDs 12. In the illustrated embodiment, the master liquid crystal panel 10 is essentially rectangular.

As viewed in FIG. 1, the master liquid crystal panel 10 includes a first alignment mark A1 located at a top-left corner (not labeled) thereof, a second alignment mark B1 located at a top-right corner (not labeled) thereof, a third alignment mark C1 located at a bottom-left corner (not labeled) thereof, and a fourth alignment mark D1 located at a bottom-right corner (not labeled) thereof. Each of the first alignment mark A1, the third alignment mark C1, and the fourth alignment mark D1 is essentially cross-shaped. The second alignment mark B1 is essentially triangular.

The first, second, third, and fourth alignment marks A1, B1, C1, D1 are centrosymmetric around a center (not labeled) of the master liquid crystal panel 10. Centers (not labeled) of the first, second, third, and fourth alignment marks A1, B1, C1, D1 can be considered to cooperatively define an imaginary rectangle, and the first, second, third, and fourth alignment marks A1, B1, C1, D1 maintain a same distance from the center of the master liquid crystal panel 10. The sides of the imaginary rectangle are parallel to corresponding adjacent side edges of the master liquid crystal panel 10.

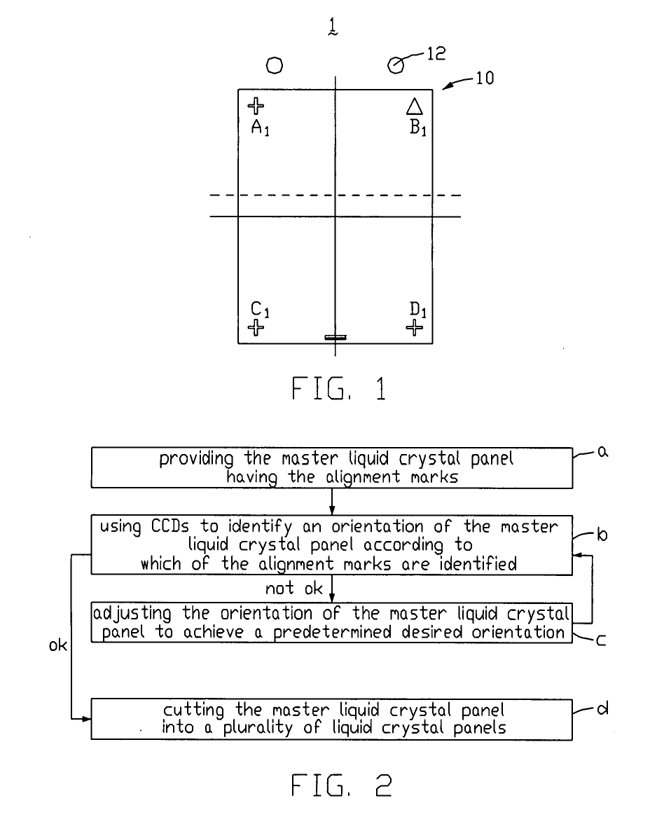

Referring to FIG. 2, an exemplary method for cutting the master liquid crystal panel 10 includes the following steps. In step (a), the master liquid crystal panel 10 having the alignment marks A1, B1, C1, D1 is placed on a rotatable platform (not shown). The master liquid crystal panel 10 is supported by the platform, and can be rotated along with the platform an angle selected from the group consisting of 90°, 180°, and 270°. In step (b), the CCDs 12 are provided. The CCDs 12 are connected to an identification circuit (not shown). The identification circuit stores a predetermined desired identification result, which corresponds to a predetermined desired orientation of the master liquid crystal panel 10. The CCDs 12 can thereby enable the identification circuit to identify whether the master liquid crystal panel 10 is in the desired orientation. In this embodiment, if the CCDs 12 identify the first and second alignment marks A1, B1 as being the alignment marks nearest the CCDs 12, the master liquid crystal panel 10 is deemed to be in the desired orientation. For example, once the master liquid crystal panel 10 is in the desired orientation, then when the master liquid crystal panel 10 is cut into a plurality of individual liquid crystal panels, peripheral parts (not labeled) of each of the liquid crystal panels maintain desired distances relative to a display part of the liquid crystal panel. If the master liquid crystal panel 10 is identified as being in the desired orientation, a cutting signal is generated. The cutting signal indicates that a cutting procedure can be launched. Thus, the procedure goes directly to step (d) described below.

On the other hand, if the captured alignment marks are the first and third alignment marks A1, C1, the second and fourth alignment marks B1, D1, or the third and fourth alignment marks C1, D1, the master liquid crystal panel 10 is identified as not being in the desired orientation. Accordingly, a rotating signal is generated. The rotating signal indicates that the master liquid crystal panel 10 is required to be rotated, for example, 90°, 180°, or 270°. The angle of rotation is determined according to the identification of the two captured alignment marks. Thus, the procedure goes to step (c) described below.

In step (d), the master liquid crystal panel 10 is cut into the individual liquid crystal panels, whereupon the procedure is completed. In step (c), the master liquid crystal panel 10 is rotated in order to achieve the desired orientation. Thereupon, the procedure returns to step (b). In many cases, if step (c) needs to be performed, it need only be performed once; and thereafter the procedure goes directly from step (b) to step (d). However, if necessary, the cycle of steps (b) and (c) can be performed iteratively until the cutting signal is generated in step (b). In an alternative embodiment, in step (d), the master liquid crystal panel 10 may be cut into only a single individual liquid crystal panel, according to the particular configuration of the master liquid crystal panel 10 itself. In step (d), the cutting process can be performed by using an edged cutting tool, or can be a so-called scribing and breaking (shearing) process.

In summary, the second alignment mark B1 is different from all of the first, third, and fourth alignment marks A1, C1, D1. This helps the CCDs 12 to determine whether the master liquid crystal panel 10 is accurately positioned in the desired orientation. The platform can automatically adjust the orientation of the master liquid crystal panel 10 in response to an identification by the CCDs 12 connected to the identification circuit that the master liquid crystal panel 10 is not accurately positioned in the desired orientation. Such adjustment can be repeated automatically if and as necessary until the master liquid crystal panel 10 is accurately positioned in the desired orientation. This automatic functioning by the cutting system 1 is performed with no need for manual work. The process efficiently obtains the correct orientation of the master liquid crystal panel 10. Thus, the cutting system 1 has improved performance and good reliability. In particular, the yield of liquid crystal panels can be improved.

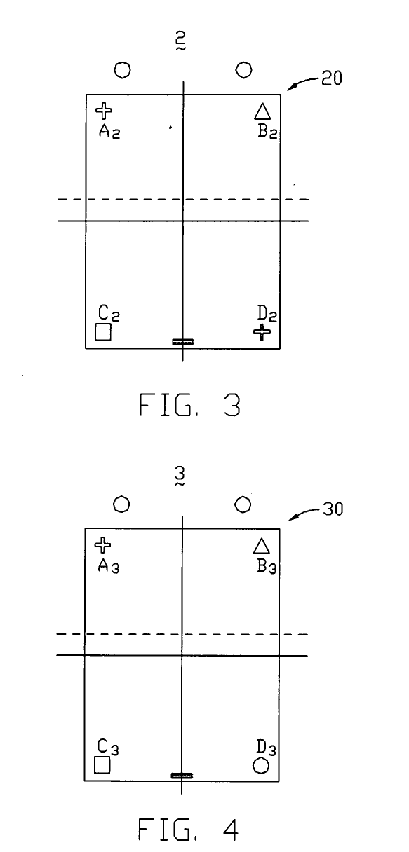

Referring to FIG. 3, a cutting system 2 for a master liquid crystal panel according to a second embodiment of the present invention is similar to the cutting system 1. However, the cutting system 2 includes a master liquid crystal panel 20 and two CCDs (not labeled). As viewed in FIG. 3, the master liquid crystal panel 20 includes a first alignment mark A2 located at a top-left corner (not labeled) thereof, a second alignment mark B2 located at a top-right corner (not labeled) thereof, a third alignment mark C2 located at a bottom-left corner (not labeled) thereof, and a fourth alignment mark D2 located at a bottom-right corner (not labeled) thereof. Each of the first and fourth alignment marks A2, D2 is essentially cross-shaped. The second alignment mark B2 is essentially triangular. The third alignment mark C2 is essentially rectangular or square. In other respects, the cutting system 2 has features and advantages similar to those described above in relation to the cutting system 1. An exemplary method for cutting the master liquid crystal panel 20 is similar to the exemplary method described above in relation to the master liquid crystal panel 10. However, if step (c) needs to be performed, it need only be performed once. This is because the CCDs connected to an identification circuit (not shown) can determine an exact orientation of the master liquid crystal panel 20 based on the unique combination of the two alignment marks detected at the two adjacent corners of the master liquid crystal panel 20.

Referring to FIG. 4, a cutting system 3 for a master liquid crystal panel according to a third embodiment of the present invention is similar to the cutting system 1. However, the cutting system 3 includes a master liquid crystal panel 30 and two CCDs (not labeled). As viewed in FIG. 4, the master liquid crystal panel 30 includes a first alignment mark A3 located at a top-left corner (not labeled) thereof, a second alignment mark B3 located at a top-right corner (not labeled) thereof, a third alignment mark C3 located at a bottom-left corner (not labeled) thereof, and a fourth alignment mark D3 located at a bottom-right corner (not labeled) thereof. The first alignment mark A3 is essentially cross-shaped, the second alignment mark B3 is essentially triangular, the third alignment mark C3 is essentially rectangular or square, and the fourth alignment mark D3 is essentially circular. In other respects, the cutting system 3 has features and advantages similar to those described above in relation to the cutting system 1. An exemplary method for cutting the master liquid crystal panel 30 is similar to the exemplary method described above in relation to the master liquid crystal panel 20.

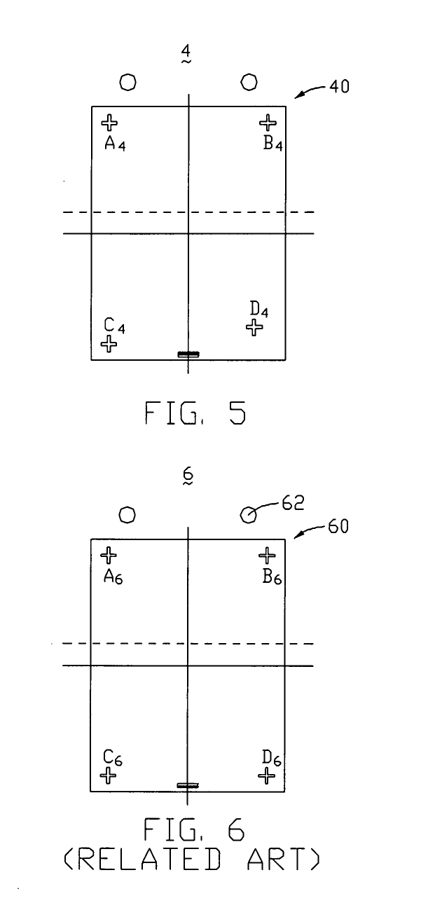

Referring to FIG. 5, a cutting system 4 for a master liquid crystal panel according to a fourth embodiment of the present invention is similar to the cutting system 1. However, the cutting system 4 includes a master liquid crystal panel 40 and two CCDs (not labeled). As viewed in FIG. 5, the master liquid crystal panel 40 includes a first alignment mark A4 located at a top-left corner (not labeled) thereof, a second alignment mark B4 located at a top-right corner (not labeled) thereof, a third alignment mark C4 located at a bottom-left corner (not labeled) thereof, and a fourth alignment mark D4 located at a bottom-right corner (not labeled) thereof. Each of the first, second, third and fourth alignment marks A4, B4, C4, D4 is essentially cross-shaped. The first, second, and third alignment marks A4, B4, C4 are centrosymmetric around a center (not labeled) of the master liquid crystal panel 40. That is, the first, second, and third alignment marks A4, B4, C4 maintain a same first distance from the center of the master liquid crystal panel 40. The fourth alignment mark D4 maintains a second distance from the center of the master liquid crystal panel 40, wherein the second distance is less than the first distance.

In a process of cutting the master liquid crystal panel 40, the different first and second distances can help the cutting system 4 to identify whether the master liquid crystal panel 40 is accurately positioned in a predetermined desired orientation. In particular, the desired orientation of the master liquid crystal panel 40 is a position in which the third and fourth alignment marks C4, D4 are nearest the CCDs. In other respects, the cutting system 4 has features and advantages similar to those described above in relation to the cutting system 1.

Further or alternative embodiments may include the following. In a first example, the first, second, third, and fourth alignment marks have a same shape, but have different sizes. In a second example, each of the first, second, third, and fourth alignment marks has one of the following shapes: trapezoidal, pentagonal, hexagonal, or another suitable shape. In a third example, the alignment marks of two diagonally opposite corners are non-centrosymmetric around the center of the master liquid crystal panel. In a fourth example, none of the alignment marks of the master liquid crystal panel is centrosymmetric around the center of the master liquid crystal panel. In a fifth example, the pair of CCDs may be replaced with a linear sensor, a linear detector, or another suitable detecting apparatus that can detect and identify alignment marks at two adjacent corners of the master liquid crystal panel. In a sixth example, the alignment marks can be located adjacent to an imaginary horizontal or vertical axis of the master liquid crystal panel, or at any other suitable positions on the master liquid crystal panel. In a seventh example, the master liquid crystal panel can have an essentially circular shape or another suitable shape. In an eighth example, at least one of the corners of the master liquid crystal panel can include two, three, or more alignment marks. In such case, the plural alignment marks at each of such corners can be same or can be different from each other. However, the alignment mark configuration at least one of the corners of the master liquid crystal panel must be different from the alignment mark configuration at least one of the other corners of the master liquid crystal panel.

It is believed that the present embodiments and their advantages will be understood from the foregoing description, and it will be apparent that various charges may be made thereto without departing from the spirit or scope of the invention or sacrificing all of its material advantages, the examples hereinbefore described merely being preferred or exemplary embodiments of the invention.

What is claimed is:

1. A cutting system for a master liquid crystal panel, comprising:
a master liquid crystal panel, the master liquid crystal panel comprising:
a plurality of corners; and
a plurality of alignment marks respectively provided at the corners, at least two of the alignment marks at two diagonal corners being different from each other, the difference being selected from the group consisting of a difference in shape and a difference in distance from a center of the master liquid crystal panel; and
at least one identification apparatus positioned adjacent to two adjacent corners of the master liquid crystal panel at any one time, and configured to detect and identify the alignment marks at such two adjacent corners.

2. The cutting system as claimed in claim 1, wherein the master liquid crystal panel is essentially rectangular, and comprises four corners.

3. The cutting system as claimed in claim 1, wherein when the difference is in distance from the center of the master liquid crystal panel, all of the alignment marks have a same shape.

4. The cutting system as claimed in claim 1, wherein when the difference is in shape, each of the alignment marks maintains an equal distance from the center of the master liquid crystal panel.

5. The cutting system as claimed in claim 3, wherein each of the alignment marks has a shape selected from the group consisting of: triangular, circular, cross-shaped, and rectangular.

6. The cutting system as claimed in claim 4, wherein the alignment marks are centrosymmetric around the center of the master liquid crystal panel.

7. The cutting system as claimed in claim 1, wherein the at least one identification apparatus comprises two charge-coupled devices.

8. The cutting system as claimed in claim 1, wherein the alignment marks are non-centrosymmetric around the center of the master liquid crystal panel.

9. A method for cutting a master liquid crystal panel into at least one individual liquid crystal panel, the method comprising:
providing a master liquid crystal panel, wherein the master liquid crystal panel comprises a plurality of corners and a plurality of alignment marks respectively provided at the corners, and at least two of the alignment marks at two diagonal corners are different from each other;
providing an identification apparatus to identify an orientation of the master liquid crystal panel by identifying the alignment marks at two adjacent of the corners of the master liquid crystal panel; and
cutting the master liquid crystal panel into at least one liquid crystal panel, if the orientation of the master liquid crystal panel is identified as being correct.

10. The method as claimed in claim 9, further comprising changing the orientation of the master liquid crystal panel, if the orientation of the master liquid crystal panel is identified as being not correct.

11. The method as claimed in claim 10, wherein changing the orientation of the master liquid crystal panel comprises rotating the master liquid crystal panel a predetermined angle.

12. The method as claimed in claim 11, wherein the predetermined angle is selected from the group consisting of 90°, 180°, and 270°.

13. The method as claimed in claim 12, wherein the predetermined angle is based on the identification of the alignment marks at the two adjacent corners of the master liquid crystal panel.

14. The method as claimed in claim 9, further comprising launching a cutting procedure if the orientation of the master liquid crystal panel is identified as being correct.

15. The method as claimed in claim 9, wherein the identification apparatus comprises two charge-coupled devices.

16. The method as claimed in claim 9, wherein cutting the master liquid crystal panel comprises a process selected from the group consisting of using an edged cutting tool, and scribing and breaking the master liquid crystal panel.

17. A cutting system for a master liquid crystal panel, comprising:
a rectangular master liquid crystal panel, the master liquid crystal panel comprising:
a plurality of corners; and
a plurality of alignment marks respectively provided at the corners, at least two of the alignment marks at two diagonal corners being different from each other, the difference including at least one of a difference in shape and a difference in distance from a center of the master liquid crystal panel; and
at least one identification apparatus positioned adjacent to two adjacent corners of the master liquid crystal panel at any one time, and configured to detect and identify the alignment marks at such two adjacent corners.
